(19) United States
(12) Patent Application Publication
(10) Pub. No.: US 2012/0030871 A1
(43) Pub. Date: Feb. 9, 2012

(54) WATER STOPPER

(76) Inventor: LEONARD ERIKSSON, Oxnard, CA (US)

(21) Appl. No.: 12/478,180

(22) Filed: Jun. 4, 2009

Related U.S. Application Data
(60) Provisional application No. 61/158,670, filed on Mar. 9, 2009.

(51) Int. Cl. A47K 1/14; B23P 17/00

(52) U.S. Cl. 4/609; 29/527.1

(57) ABSTRACT

A waterproof article for stopping water leakage from a bathroom tub or shower enclosure and the method of using the article, having a vertical and horizontal member adjoined at a right angle, of which a rib is projected perpendicularly from the longitudinal center line of both members in continuous contact along the entire length of the rib. The waterproof adhesive backing initially protected with a strip of film, is used to fix the article on the center line of where a shower door will install. A bore on the vertical member is utilized to secure the article on a bathtub flange or shower pan. All seams and crevices about the perimeter of the article are liberally caulked using silicon during installation to ensure addition protection.

### CROSS-REFERENCE TO RELATED APPLICATION

This application claims the benefit of the priority date of provisional application 611/58670 filed on Mar. 9, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally relates to waterproofing articles, and particularly, to articles that waterproof shower basins and bathtubs.

Waterproofing shower basins and bathtubs during construction are commonly known in the art. For example, U.S. Pat. No. 6,401,418 to Senn discloses a method of installing flooring in a bathroom utilizing a coving cap attached to a bathtub wall or shower enclosure to form a waterproof and flexible seal. The edge of the flooring material is inserted into an inverted “J” shaped coving cap, which traps the edge of the flooring, but allows it to move up and down slightly. The corners of the flooring are mitered and sealed to form a waterproof corner, and the entire floor becomes a waterproof basin.

U.S. Pat. No. 5,123,129 to Lyons discloses a shower stall and bathtub enclosure having door assemblies which use a hinged multipanel door design, with special waterproof hinges and seams, adjustable wall panels retained by waterproof mounting sheaths, and door panel deflector sections with corresponding deflector shields to deflect water which collects on the inner surfaces of the door panels, and a door closure system which firmly secures the doors when the door assembly is closed.

While both Senn and Lyons seek to prevent damages caused by water flowing over a bathtub or shower enclosure, they approach the problem from a conventional perspective. Unlike Senn, the present invention is not concerned with forming a flexible seal where the floor meets a bathroom such as a bathtub or shower enclosure to prevent water from seeping into the edges of the flooring; and unlike Lyons, the present invention does not involve the use of door assemblies to deflect water that may escape a shower room or bathtub. Instead, the present invention prevents water from escaping a bathtub or shower assembly by focusing on the outside corners of a bathtub or shower enclosure where water is more likely to escape through the sides of a shower curtain or shower door.

It is therefore an object of the present invention to address the problem of structural damage caused by water seeping off or wicking up from a bathtub flange or shower pan, by an article comprising an elbow having an inner rib projection and an outer adhesive backing.

### SUMMARY

The present invention comprises an article for stopping water leakage. In the preferred embodiment of the article, a rectangular elbow comprising a vertical member and horizontal member are adjoined at a right angle at one end of the vertical member and one end of the horizontal member.

A rib projecting from the longitudinal center line of the vertical member and horizontal member, in continuous contact with the vertical and horizontal members along the entire length of the rib, is utilized as a dam to inhibit the flow of water off a bathtub flange or shower pan.

A waterproof adhesive backing disposed on the surface of the horizontal member and vertical member opposite the surface on which the rib is disposed, is utilized to fix the article on the center line of where a shower door would be installed. The waterproof adhesive further comprises a protective film disposed opposite the adhesive surface attached to the horizontal member and vertical member, wherein the protective film is detached prior to installation.

A bore disposed centrally between the upper most edge of the vertical member and the rib is utilized to secure the article on a bathtub flange or shower pan. In the preferred embodiment, a screw is utilized to secure the article to the wall structure of a bathtub or shower pan. A predetermined break line disposed latitudinal on the outer edge of the lower portion of the rib and horizontal member comprises a means of breaking off the excess material once the article is installed.

The method of installing the article of the preferred embodiment, comprises the steps of; firstly, marking the center line of where a shower door will install; secondly, removing the protective film from the surface of the adhesive backing to install the article on the markings that show the center of the shower door; thirdly, installing the article by using a screw to secure the article to the wall structure, of which a shim may be inserted between the wall structure and the article to level the article horizontally and vertically; fourthly, caulking all seams or crevices about the perimeter of the article liberally to ensuring that the article is additionally protected; fifthly, removing the protective backing of a substantially rectangular single piece of waterproofing adhesive patch to attach it on the vertical member of the article and wall structure; sixthly, caulking all seams or crevices about the perimeter of the adhesive patch and entire length of rib projecting from the vertical member to provide additional protection again water leakage.

### BRIEF DESCRIPTION OF THE FIGURES

FIG. 1a is a perspective view of a preferred embodiment to the waterproofing article.

FIG. 1b is a perspective view of another preferred embodiment of the waterproofing article.

FIG. 2a is a perspective view of a shower pan showing two waterproofing articles installed.

FIG. 2b is a broken perspective view of a shower pan showing the waterproofing article installed.

FIG. 3a is a perspective view of a bathtub showing two waterproofing articles installed.

FIG. 3b is a cutaway view of the bathtub showing the waterproofing article installed.

### DETAILED DESCRIPTION

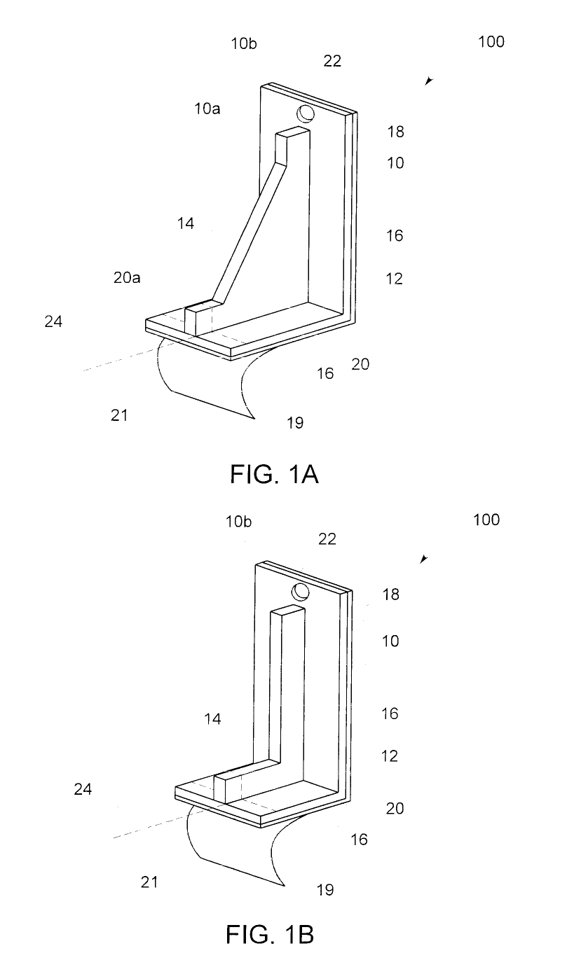

Referring to FIGS. 1a and 1b, an article for stopping water leakage is shown and described. In the preferred embodiment of the article 100, a rectangular elbow comprising a vertical member 10 and horizontal member 20 are adjoined at a right angle 12 at one end of the vertical member 10 and one end of the horizontal member 20.

Still referring to FIGS. 1a and 1b of the article 100, a rib 14 projecting from the longitudinal center line 24 of the vertical member 10 and horizontal member 20, in continuous perpendicular contact 16 with the vertical 10 and horizontal 20 members along the entire length of the rib 14, is utilized as a dam to inhibit the flow of water off a bathtub flange or shower pan (shown in subsequent figures).

Referring to FIG. 1a of the preferred embodiment, the elevation of the rib 14 from the surfaces of the horizontal 20 and vertical 10 members changes, causing the rib 14 to slope from the first extreme end 10a of the vertical member 10 to the second extreme end 20a of the horizontal member 20.

Referring to FIG. 1b showing another preferred embodiment, the rib 14 is projected perpendicularly from the surfaces of the horizontal 20 and vertical 10 members, causing the rib 14 to extend parallel to both surfaces to form a right angle elbow.

Referring now to both FIGS. 1a and 1b of the article 100, a waterproof adhesive backing 18 disposed on the surface of the horizontal member 10 and vertical member 20 opposite the surface on which the rib 14 is disposed, is utilized to fix the article 100 on the center line of where a shower door would be installed. The waterproof adhesive backing 18 further comprises a protective film 19 disposed opposite the adhesive surface attached to the horizontal member 10 and vertical member 20, wherein the protective film 19 is detached prior to installation.

Still referring to FIGS. 1a and 1b, a bore 22 disposed on the latitudinal center line 24 of the vertical member 10 between the upper most edge 10 b of the vertical member 10 and the rib 14 is utilized to secure the article 100 on a bathtub flange or shower pan. In the preferred embodiment, a screw (not shown) is utilized to secure the article 100 to the wall structure of a bathtub or shower pan.

In the preferred embodiment of the article 100 shown in FIGS. 1a and 1b, a predetermined break line 21 disposed latitudinal on the surfaces of the rib 14 and horizontal member 10 comprises a means of breaking off any excess length of the article 100 after installation.

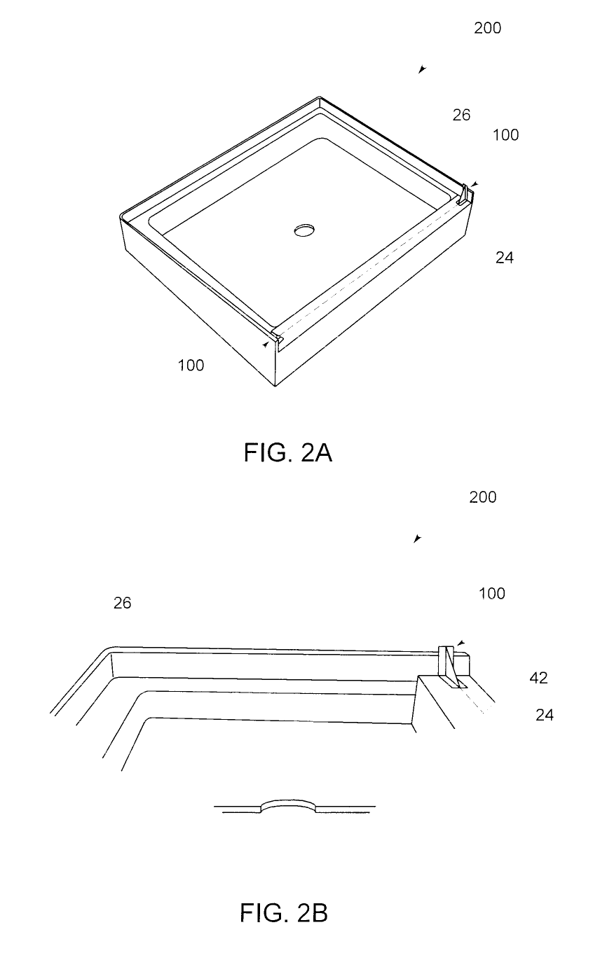

Now referring to FIGS. 2a and 2b, a shower pan 200 is shown comprising two articles 100 installed on a threshold 42, wherein the article 100 is disposed on the center line 24 of where a shower door would be installed and is anchored to the wall structure 26 of the shower pan 200.

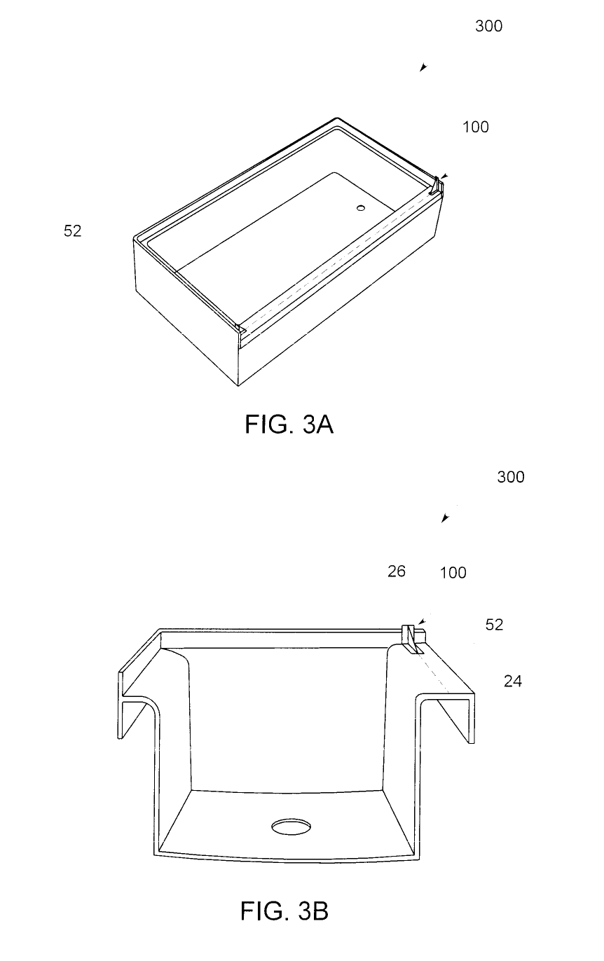

Now referring to FIGS. 3a and 3b of the article 100, a bathtub 300 is shown comprising two articles 100 installed on the bathtub flange 52, wherein the article 100 is disposed on the center line 24 of where a shower door would be installed and is anchored to the wall structure 26 of the bathtub 300.

The method of installing the preferred embodiment of the article 100, comprises the steps of; firstly, marking the center line of where a shower door will install; secondly, removing the protective film from the surface of the adhesive backing to install the article on the markings made in the previous step; thirdly, installing the article by using a screw through the bore in the vertical member to secure the article to the wall structure, of which a shim or similar tools may be inserted between the wall structure and the article to level the article horizontally and vertically; fourthly, caulking all seams or crevices about the perimeter of the article liberally to ensuring that the article is waterproof; fifthly, removing the protective backing of a substantially rectangular single piece of waterproofing adhesive patch to attach it on the vertical member of the article and wall structure; sixthly, caulking all seams or crevices about the perimeter of the adhesive patch and entire length of rib projecting from the vertical member to provide additional protection again water leakage.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An article for stopping water leakage, comprising:
a. an elbow, comprising a vertical member and horizontal member wherein one end of the vertical member adjoins one end of the horizontal member at an angle;
b. a rib projecting from the vertical member and horizontal member, wherein the rib is in continuous contact with the vertical and horizontal members along the entire length of the rib;
c. an adhesive backing disposed on the surface of the horizontal member and vertical member opposite the surface on which the rib is disposed; and
d. at least one bore disposed in the vertical member.

2. An article for stopping water leakage, comprising:
a. a rectangular elbow, comprising a vertical member and horizontal member wherein one end of the vertical member adjoins one end of the horizontal member at a right angle;
b. a rib projecting from the longitudinal center of the vertical member and horizontal member, wherein the rib is in continuous contact with the vertical and horizontal members along the entire length of the rib;
c. a waterproof adhesive backing disposed on the surface of the horizontal member and vertical member opposite the surface on which the rib is disposed, wherein the waterproof adhesive further comprises a protective film disposed opposite the adhesive surface attached to the horizontal member and vertical member; and
d. a bore disposed on the longitudinal center of the vertical member between the upper most edge of the vertical member and the rib.

3. The method of using the article for stopping water leakage, comprising the steps of,
a. marking the center line of where a shower door will install;
b. removing the protective film disposed on the surface of the adhesive backing to install on the markings;
c. installing the article and utilizing a screw to secure the article with the wall structure, of which shim inserts disposed between the wall structure and the article may be utilized to level the article;
d. caulking all seams or crevices about the perimeter of the article liberally;
e. mending a substantially rectangular single piece of waterproofing adhesive patch on the vertical member of the article and wall structure; and
f. caulking all seams or crevices about the perimeter of the adhesive patch and entire length of rib projecting from the vertical member.

4. The article of claim 1, wherein the rib extends perpendicularly from the surfaces of the vertical and horizontal members at a point of connection disposed on the longitudinal center of the members.

5. The article of claim 1, wherein the elevation of the rib from the surfaces of the horizontal and vertical members changes, causing the rib to slope from one extreme end of the vertical member to one extreme end of the horizontal member.

6. The article of claim 1, wherein the rib extends perpendicularly from the surfaces of the vertical and horizontal members at a point of connection disposed on a longitudinal edge of the horizontal and vertical members.

7. The article of claim 1, wherein the rib and horizontal member comprises at least one break line disposed at the non elbow end of the horizontal member latitudinal across on the surfaces.

8. The article of claim 1, wherein the vertical member is 3 inches by 1 inch and the horizontal member is 1 inch by 1 inch comprising two bores disposed to the right and left side of the rib projecting from the vertical member.

9. The article of claim 2, wherein the rib and horizontal member comprises at least one break line disposed at the non elbow end of the horizontal member latitudinal across on the surfaces.

10. The article of claim 5, wherein the vertical member is 3 inches by 2 inches and the horizontal member is 2 inches by 1 inch.
